(19) United States
(12) Patent Application Publication
(10) Pub. No.: US 2011/0060992 A1
(43) Pub. Date: Mar. 10, 2011

(54) VIDEO-COLLABORATION APPARATUS AND METHOD

(76) Inventors: Oliver Matthew JEVONS, London (GB); Mark David John LYDON, Cambridge (GB); Marko KRZNARIC, London (GB)

(21) Appl. No.: 12/876,694

(22) Filed: Sep. 7, 2010

(30) Foreign Application Priority Data
Sep. 7, 2009 (GB) 0915592.0

(51) Int. Cl. G06F 3/00

(52) U.S. Cl. 715/719

(57) ABSTRACT

A video collaboration apparatus provides a video presentation. The apparatus includes an input interface, a presentation interface to output an output media stream that includes one or more input media streams presented in the display, a user interface to capture events caused by a user and to generate data dependent on configuration events, an output generator to generate the output media stream, wherein the user interface generates a graphical user interface to capture configuration events and the graphical user interface includes one or more objects presenting displayed input media streams.

### FIELD OF THE INVENTION

The present invention relates to video-collaboration apparatuses and methods, such as those which display, at a participating apparatus, video streams from other participating apparatuses.

### BACKGROUND OF THE INVENTION

Video collaboration is an increasingly important method of communication. Video-collaboration involves a number of participating apparatuses providing media streams of video and sometimes other media to other participating apparatuses and presenting a number of those media streams at one or more devices. Conventionally, each media stream is presented in a separate window at a display associated with a participating apparatus.

One conventional approach to video-collaboration involves a server which receives media streams from a number of video-collaboration apparatuses acting as participant clients. The server transmits each of the received media streams to each of the participant clients. Each participating client then displays the media streams transmitted by the server. A user at each participating client is then able to view media streams from all participant clients to create a virtual meeting. The server approach involves a data stream multiplication process to provide media streams for each participating client. This process is known to the reader. The server approach allows video-collaboration sessions to be scaled to accommodate potentially large numbers of participants. Another approach involves a peer-to-peer network of participating video-collaboration devices.

In conventional video collaboration, limitations arise in the configuring of the presentation of media streams from the multiple participants. In some cases, a large number of participants or media streams may cause a crowded presentation which may limit how effective a video-collaboration will be for a user. Additionally, the location of windows representing different media streams are typically arbitrary which may not be ideal for a given video-collaboration session.

### BRIEF DESCRIPTION OF ASPECTS OF THE INVENTION

An aspect of the invention provides a video-collaboration apparatus operable to provide a video-collaboration presentation, the apparatus including:
an input interface operable to receive one or more input media streams;
a presentation interface operable to output an output media stream to a display to provide the video-collaboration presentation, the output media stream including one or more of said one or more input media streams to be presented at the display;
a user interface operable to capture configuration events caused by the user and generate configuration data dependent on said configuration events;
an output generator operable to generate the output media stream dependent on the configuration data to display one or more of the input media streams in the video-collaboration presentation configured by the events caused by the user,
and wherein the user interface is operable to generate a graphical user interface to capture configuration events,
and wherein the graphical user interface generated includes one or more objects representing the one or more displayed input media streams.

This aspect of the invention may provide a video-collaboration apparatus which allows a user to configure the presentation of media streams. For example, the user may configure which input media streams are to be presented at the display. Also for example, the user may configure the size and/or the relative size of windows in which input media streams are presented. Also for example, the user may configure the positions of windows in which the input media streams are presented.

The network interface may be operable to receive said one or more input media streams from a video-collaboration server.

The apparatus may include a computer interface operable to receive one or more media streams from a computer associated with the apparatus.

The apparatus may include a hardware interface operable to receive one or more media streams from hardware associated with the apparatus.

The network interface may be operable to receive media streams in two or more media types, each type corresponding to a different latency and/or bandwidth on the video-collaboration network.

The user interface may be operable to generate configuration data defining whether a given one of the one or more input media streams are to be included in the output media stream for presentation at the display.

The user interface may be operable to generate configuration data defining a layout for the video-collaboration presentation.

The user interface may be operable to generate configuration data defining a layout having a position for each input media stream as presented within the video-collaboration presentation.

The output generator may be further operable to generate another output media stream and the presentation interface may be further operable to output said another output media stream to another display.

The user interface may be operable to generate a graphical user interface which includes a presentation field replicating the video-collaboration presentation and which includes an object replicating each input media stream presented. Each object may visually resemble a window dedicated to the display of an input media stream

The user interface may be operable to generate a graphical user interface which replicates the video-collaboration presentation at a reduced size.

The user interface may be operable to generate a graphical user interface which replicates the video-collaboration presentation at a reduced resolution.

The user interface may be operable to generate a graphical user interface which replicates the video-collaboration presentation at a reduced frame rate.

The user interface may be operable to generate a graphical user interface which includes a candidate field for objects representing input media streams as candidates for inclusion in the output media stream and to allow the user to create a copy of the object and drag said copy of the object from the candidate field to the presentation field to indicate that a given input media stream should be presented.

The user interface may be operable to generate a graphical user interface which allows a user to cause configuration events by manipulating the objects within the presentation field to move and/or resize objects within the presentation field to capture configuration data determining positions for given input media streams presented within a layout of the video-collaboration presentation.

The network interface may be operable to extract identification data from the input media streams, the identification data identifying an origin in the video-collaboration for the media stream. An origin may be an originating video-collaboration apparatus.

The graphical user interface may replicate the video-collaboration presentation to allow a user to configure the video-collaboration presentation by manipulating the graphical user interface.

The user interface may be operable to visually identify groups of objects having a common origin, said groups defined dependent on the identification data. The identification data may be Synchronisation Source (SSRC) data provided by a Real-Time Protocol (RTP) which may me used for transmission in the video-collaboration network. The SSRC data may include data identifying at which participating apparatus each media stream originates. The user interface may be operable to visually identify different media streams originating at a common participating device. For example, objects representing given media streams for a Word™ document, a Powerpoint™ and a video signal may be located together. In another example objects may be provided with a text tag identifying a groups of objects representing media streams from a common origin and/or identifying an origin. In another example objects may be colour coded to identify groups with a common origin.

The identification data may further identify groups of media streams having a common origin wherein each group from a common origin includes a video stream.

The output generator may be operable to generate an output media stream dependent on the configuration data by including in the output media stream one or more input media streams which correspond to a list of identification data wherein the list is included in the configuration data.

The user interface may be operable to group objects by their position relative to each other, said grouping dependent on said identified groups of media streams to indicate to the user groups of media streams having a common origin.

The presentation interface may be operable to provide additional output media streams for presentation at additional displays.

One aspect of the present invention provides a method of controlling one or more displays for a video-collaboration apparatus, each display presenting a first video stream including one or more second video streams received by the video-collaboration apparatus to provide one or more first video stream presentations, the method comprising:

receiving the one or more second video streams;
presenting a graphical user interface including objects representing the one or more first video presentations;
receiving events caused by a user at the user interface to allow the user to configure one or more video presentations;
generating configuration data using the events; and
adjusting the one or more first video stream presentations dependent on the configuration data.

The configuration data may define whether each second video stream is to be included in each first video stream.

The configuration data may define a layout for each first video stream when displayed. The layout may comprise the position of each second video stream as it appears in each first video stream when each first video stream is presented. The layout may comprise the size of each second video stream as it appears in each first video stream when each first video stream is displayed.

The user interface may be a graphical user interface. Presenting the graphical user interface may comprise generating objects representing each second video stream and receiving events corresponding to a user manipulating the first objects. Generating the graphical user interface may comprise generating a second field displaying an object for each second video stream to be included in any first video streams as candidates for inclusion in each first video stream.

Presenting the graphical user interface may comprise presenting a first field for each first video stream, presenting in each first field an object corresponding to each second video stream included in the respective first video stream and receiving events may comprise receiving user manipulations of the objects within each first field.

Receiving events may comprise allowing a user to add objects to each first field.

Receiving events may comprise receiving events indicating that a given first video stream is to be included in the second video stream.

The method may comprise presenting the graphical user interface at a computer display associated with the display.

The method may comprise presenting the graphical user interface at the one or more displays controlled by the method.

Each display may comprise one or more component displays. Each component display may comprise individual display devices. The display devices may comprise video projectors and/or video screens.

Another aspect of the invention may provide a control for a video-collaboration apparatus, the apparatus operable to display one or more of a set of candidate media streams received from a video-collaboration network, the apparatus configurable to display a given media stream or to not display a given media stream, each media stream displayed being displayed in a display window, the control including a user interface operable to generate a graphical interface displaying a candidate field containing a graphical object representing each candidate media stream and including a presentation field containing an object representing each display window and operable to allow a user to cause events at the graphical interface which add given objects to the presentation field to determine a configuration for the apparatus in which configuration candidate media streams are displayed, and wherein the control is operable to generate configuration data describing the configuration.

Further and additional aspects of the invention will be apparent to the reader from the following illustration of exemplary embodiments of the invention.

### BRIEF DESCRIPTION OF THE DRAWINGS

FIG. 1 shows a video-collaboration apparatus according to an embodiment of the invention used with a video-collaboration network;

FIG. 2 shows a video-collaboration apparatus according to the embodiment of the invention of FIG. 1;

FIG. 3 shows a video-collaboration apparatus according to an alternative embodiment of the present invention;

FIG. 4 shows video-collaboration apparatuses and a video-collaboration server according to a further alternative embodiment of the invention, and illustrates media and data flows in an example operation;

FIG. 5 shows a video-collaboration apparatus according to the embodiment of FIG. 4, and illustrates the storage of data used to configure the presentation of media streams at a display;

FIG. 6 shows a video-collaboration apparatus according to the embodiment of FIGS. 4 and 5, and illustrates the updating of data used to configure the presentation of media streams at a display;

FIG. 7 shows a process for the initialisation of the layout of the presentation of media steams at a display according to a further alternative embodiment of the invention;

FIG. 8 shows a layout of windows for the presentation of media streams corresponding to the process of FIG. 7;

FIG. 9 shows a process for the addition of a window for the presentation of media stream at a display according to the embodiment of FIGS. 7 and 8;

FIG. 10 shows a layout of the presentation of media streams at a display corresponding to the process of FIG. 9;

FIG. 11 shows a process for the removal of a window for the presentation of a media stream at a display according to the embodiment of FIGS. 7 to 10;

FIG. 12 shows a layout of the presentation of media streams at a display corresponding to the process of FIG. 11;

FIG. 13 shows a process for the resizing of a window for the presentation of a media stream at a display according to the embodiment of FIGS. 7 to 12;

FIG. 14 shows a layout of windows for the presentation of media streams corresponding to the process of FIG. 13;

FIG. 15 shows a graphical user interface according to another embodiment of the present invention;

FIG. 16 shows a presentation of media streams according to the same embodiment of the invention as FIG. 15;

FIG. 17 shows another presentation of media streams according to the same embodiment of the present invention as FIGS. 15 and 16.

### DETAILED DESCRIPTION OF EMBODIMENTS OF THE INVENTION

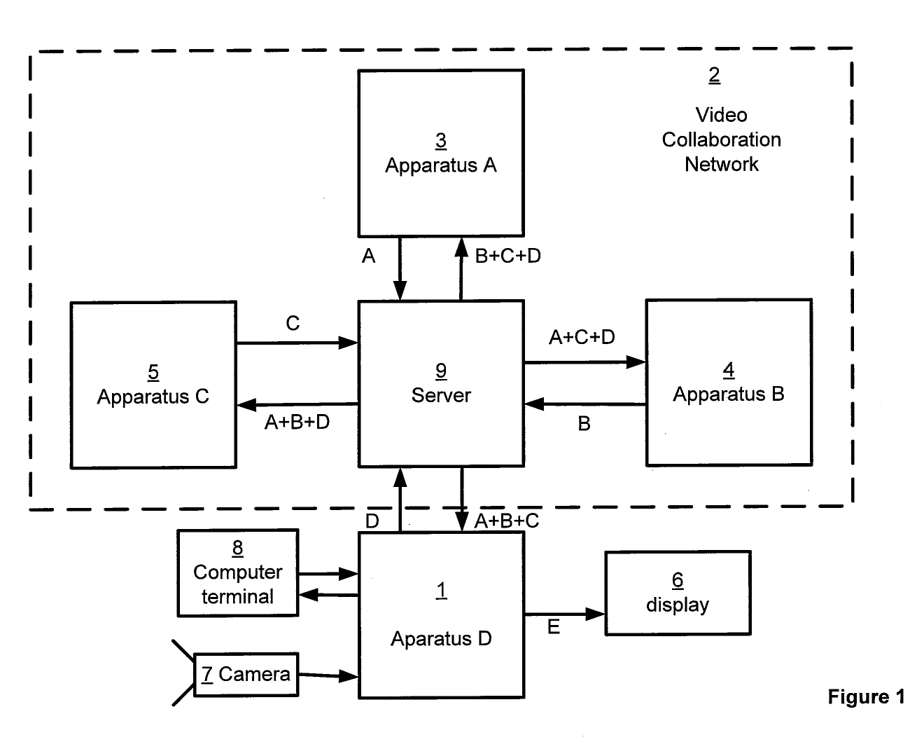

FIG. 1 shows a video conference apparatus 1. The apparatus 1 receives media streams from a video conference network 2 which includes other video-collaboration apparatuses 3, 4 and 5 which are participating in a video-collaboration session. In this embodiment the apparatus 1 receives media streams denoted by A, B and C from a network. These streams shown are in fact groups of media streams, grouped by originating apparatus 3, 4 or 5. A group has a video stream, as characteristic of video collaboration, but may also include other media such as static or moving graphics or audio. The apparatus 1 transmits a media streams denoted by D to the video-collaboration network.

The apparatus 1 also outputs a media stream denoted by E to a display apparatus 6 associated with the apparatus 1. This media stream includes media streams received from the network and captured at the apparatuses 3, 4 and 5. In this embodiment the media streams received from the network 2 also include media captured by cameras (not shown) and video interfaces (not shown) and also to multimedia and documents running on computers (not shown) associated with each apparatus 3, 4 and 5. In this embodiment, the media stream E also includes media streams captured locally at the apparatus 1. In this embodiment, the streams captured locally are captured at a camera 7 and at a computer 8 associated with the apparatus. Here, the term capture refers to any process or processes known to the reader needed to allow transmission of media from an apparatus 1, 3, 4, or 5. In this embodiment the media streams captured at the computer represent documents and multimedia running on the computer 8. The display apparatus 6 presents media stream E to allow a user of the apparatus 1 to view video, documents and multimedia received via the video-collaboration network and provided by the video-collaboration apparatuses 3,4 and 5 participating in a video collaboration.

In this embodiment, the video-collaboration network 2 includes a video-collaboration server 9 which receives media streams from each apparatus 1, 3, 4, and 5, generates a copy for each other apparatus, and transmits media streams as required by each apparatus 1, 3, 4 and 5 for a video-collaboration session. The apparatuses 1, 3, 4 and 5 may be considered as clients of the server 9. In this embodiment therefore, each apparatus 1, 3, 4 and 5 receives media streams from the other participating apparatuses 1, 3, 4 and 5. Suitable server functionality will be apparent to the reader.

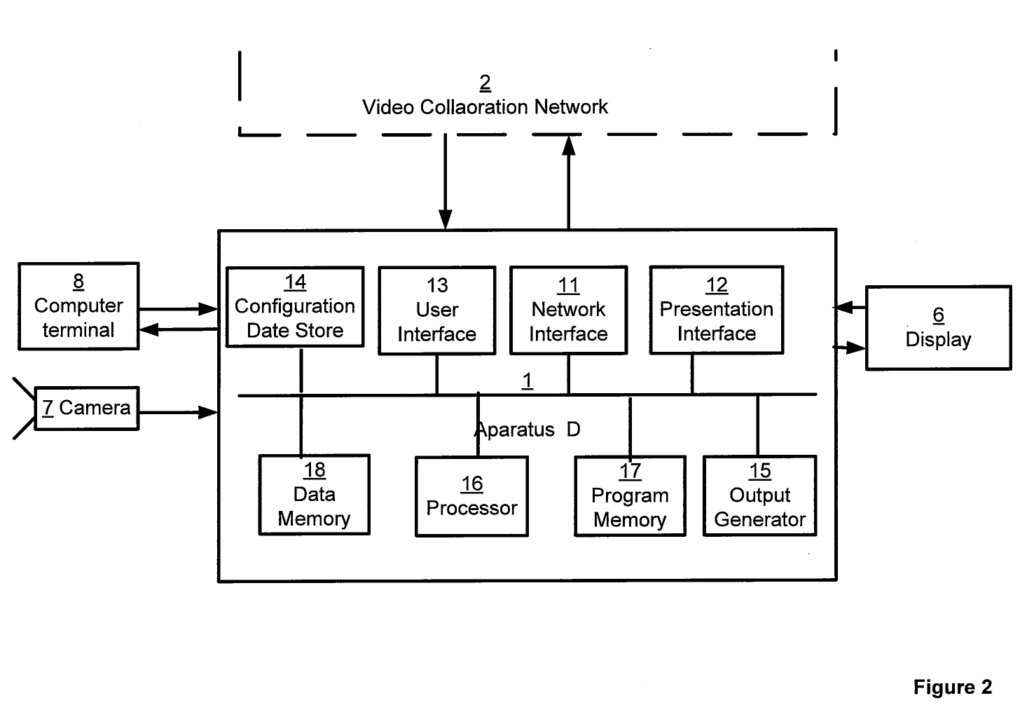

FIG. 2 shows a generalised embodiment of the apparatus 1 shown in FIG. 1. The apparatus includes an network interface 11 to receive input media streams A, B and C from the network 2. The apparatus 1 also includes a presentation interface 12 to output a media stream E to a display apparatus 6 to present a video-collaboration presentation to a user of the apparatus 1. The apparatus 1 also includes a user interface 13 to allow a user to interact with the apparatus to configure the video-collaboration presentation. In this embodiment the user interface 13 generates a graphical user interface at the computer terminal 8 which captures user interactions and allows the user to define a desired configuration for the presentation of the input media streams in the output media stream when presented at the display. The apparatus 1 includes a configuration data store 14 which stores data which defines a configuration of the presentation of the output media steam E at the display apparatus 6. The configuration is determined by user interactions with a graphical user interface (GUI) generated by the user interface 11. Typical interactions are clicks on or drags of objects presented, or other events such as x-window events known to the reader. Also included in the apparatus 1 is an output media stream generator which generates an output media stream using the configuration data to provide a presentation of the output media stream, and input media streams included in it, which conforms to the configuration determined by the user at the user interface. FIG. 2 also shows a processor 16 which executes code stored in a program memory 17 which stores code which is executable on a processor 17 to provide the functional units in the form of interfaces described with reference to FIG. 2. Also shown in FIG. 2 is a data memory which is used by the configuration data store, for example, and which also provides various data storage and buffers apparent to the reader.

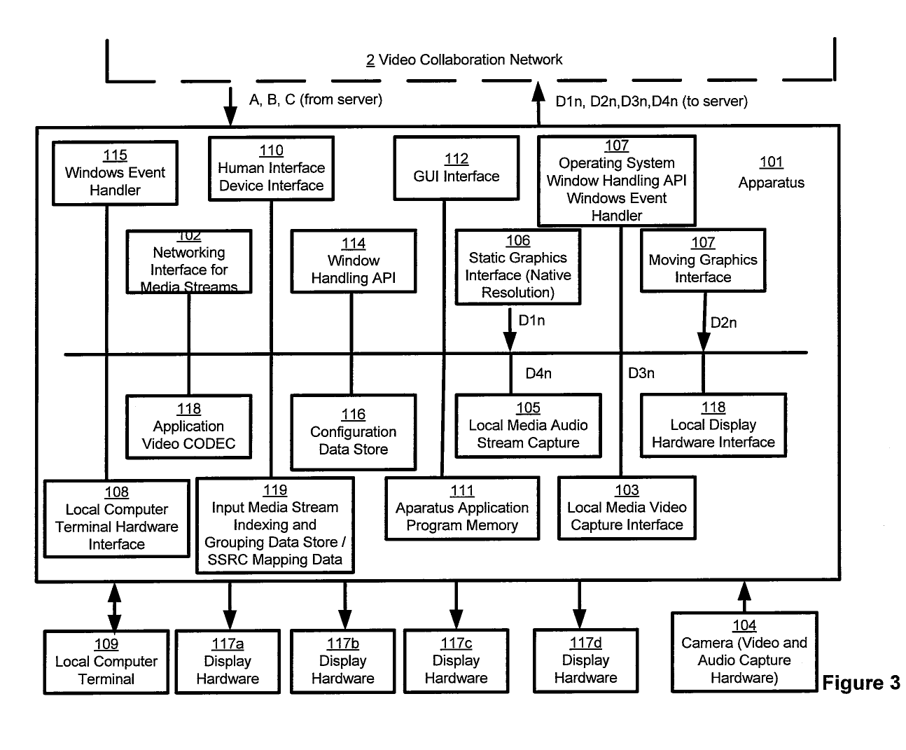

FIG. 3 shows in more detail a video-collaboration apparatus 101 according to an alternative embodiment to that of FIG. 2. The apparatus 101 receives media streams denoted by A, B and C from the video-collaboration network 2, which corresponds to the network 2 shown is FIG. 1. In FIGS. 3, A, B and C generally denote all media streams originating at apparatuses 3, 4 and 5, although media streams originating at apparatus 101 are shown in greater detail.

The apparatus 101 has a networking interface 102 for media streams A, B and C which, in this embodiment, are carried in an application protocol. The networking interface connects to physical layer interfaces using Ethernet, ATM, or other suitable protocols known to the reader. The networking interface 102 uses any suitable protocol known to the reader to receive media streams carried by application protocols. In this embodiment the application protocol carrying media stream is Real-Time Transport Protocol (RTP) carried over a TCP/IP layer of a type known to the reader and the network interface 102 uses algorithms known also to the skilled reader to service protocols such as Domain Name Resolution, packet routing and firewall traversal to facilitate the transfer of frames of media streams from one participant apparatus 3, 4 or 5 to the apparatus 101.

The networking interface 102 differentiates between different types of media stream defined in terms of network latency. This allows the apparatus 101, through the networking interface 102, and the sever 9 to use protocols which make efficient use of network capacity. Media streams that have high requirement on low-latency (video and audio streams in multimedia collaboration application) are transferred by the server and the networking interface 102 using the Real-time Transport Protocol (IETF RFC 3550) over the network layer using the User Datagram Protocol (IETF RFC 768). These media streams are often indexed and synchronized in a logical session through the use of the Real-time Transport Control Protocol (IETF RFC 3550). These protocols collectively provide identification of the participating device, 1, 3, 4 or 5 in a collaboration session and the streams each participating apparatus 1, 3, 4 or 5 is offering to other participating devices. These identifiers are stored by the input media stream indexing and grouping data store 119. This allows groups of media streams to be mapped on the basis of originating apparatus 3, 4 or 5. Media streams that have low latency requirement (static image, presentation) may be transferred by the server 9 and networking interface 102 using the File Transfer Protocol (IETF RFC 959) or Hypertext Transfer Protocol (IETF RFC 2616).

The apparatus 101 also has a video media capture interface 103 to capture video and audio from locally connected video and audio hardware 104. Various embodiments of the apparatus 101 may use any suitable protocols known to the reader depending, for example, on the video and audio hardware used with the embodiment. In this embodiment the interface 103 provides connectivity to a video camera over Firewire, S-Video, Serial and Universal Serial Bus (USB) and captures video as a media stream in the form of MJPEG-2, Digital Video (DV), uncompressed video, H.264, H.263+, MPEG-2 and Theora. Also in this embodiment a local media audio stream capture interface 105 provides connectivity to audio capture hardware 104 in the form of a camera and microphone (not shown). Connectivity to analogue microphones is provided via a digitising device included with the video and audio capture hardware 104. The digitising device digitises the analogue signal and connects to the audio stream capture interface via a high speed bus (not shown), of any form apparent to the reader, on the apparatus 101. In this embodiment the bus may be any of the types PCI, PCI-Express, AGP, although any suitable alternative known to the reader may be used in alternative embodiments. Connectivity to a digital microphone (not shown) included in the video and audio capture hardware 104 is provided in this embodiment by the audio capture interface 105 over the protocols phono, USB, Firewire or Bluetooth. The digital microphone signals to the computer as an audio device and transmits audio data as digital data with a pre-defined payload of any of the protocols PCM, WAV, MP3, or uncompressed digital audio. The audio media capture interface 105 captures audio using any of the protocols: GSM, G711, MP3, or Speex, although any other protocols known to the reader may be use in alternative embodiments.

The apparatus 101 has a static graphic interface 106 for static images. In this embodiment the interface 106 is native to the operating system 107 used by the apparatus 101. The graphics resolution used by the interface 106 is also native to the operating system 107. The interface 106 of this embodiment encodes images using the protocols: JPEG, PNG, GIF and RAW standards, although any other suitable protocols may also be used depending on the application of the apparatus 101. For example, the application may vary in the compression and image quality required.

The apparatus has a moving graphics interface 107 for moving graphics generated or run by various applications running on the operating system 107 The operating system provides a native facility for an application to request an image snapshot of the current state of the screen. Snapshots taken in quick succession produces frames the application can assemble into a video stream to be streamed along with captured video. The static 106 and moving 107 graphics interfaces allow a computer (not explicitly shown) implementing the apparatus 101 to interface with the device so that graphics can be presented as part of a video-collaboration presentation. Alternative embodiments include additional computer interfaces for other media generated or presented at the computer (not shown). In one embodiment the interface may include a computer networking interface to allow the apparatus to receive media from other computers on a local or wide area network or virtual private network which is distinct from the video-collaboration network.

A computer terminal hardware interface 108 is provided for the application to interface with computer terminal hardware 109. In this embodiment the computer terminal hardware provides a keyboard (not shown), computer display (not shown) and mouse (not shown). Suitable interfaces 108 will be known to the reader. In this embodiment the interface is provided by a USB port (not shown) and the operating system 107. In some embodiments the human interface device interface 110 is provided by the local computer hardware interface 108.

A human interface device interface 110 provides the application 111 with data defining user interactions with the apparatus 101. In this embodiment the human interface device used with the interface 110 is a mouse (not shown) used to control a cursor which is displayed as part of a graphical user interface (not shown). In this embodiment the graphical user interface is displayed at both computer terminal hardware 109 and at the display 6.

A graphical user interface, such as 13, is generated by the application 111 using a graphical user interface (GUI) interface 112. In this embodiment the operating system 107 provides an X-windows API 114, well known to the reader, which provides a set of classes used by the GUI interface 112. The operating system 107 also provides a windows event handler 115, also well known to the reader. The windows event handler 115 is used by the application 111 to capture events defining user interactions with the graphical user interface generated by the application 111. Examples of events captured include: mouse movement, mouse click, key press, mouse wheel scroll, voice command, and touch. The use of windows handling APIs and windows event handlers by applications and GUI interfaces of applications is also well known to the reader.

A configuration data store 116 provides storage for data which defines how media streams generated or combined by the application 111 are to be presented at the local displays 117a and 117b via local display hardware interface 118. In this embodiment the application 111 combines input media streams into an output media stream for presentation at local displays 117a or 117b. In this embodiment the local display hardware interface 118 controls a graphics card which has an output for each of the displays 117a and 117b. The data stored by the configuration data store 116 is defined by the events captured by the windows event handler 115 and caused by user interactions with the graphical user interface (not shown). Therefore, the graphical user interface allows the user to configure the presentation of media streams at the displays 117a and 117b. Data stored by the configuration data store 116 defines configurations for media streams received at the network interface 102 and captured at the static graphics interface 106, the moving graphics interface 107, the local media video capture interface 103, and the local audio capture interface 105. The media streams received by the apparatus 101 at the network interface 102 are typically from remote participating apparatuses, such as 3, 4 and 5. These typically include remotely captured video and audio streams as well as remotely captured static and moving graphics media streams. In this embodiment the configuration data stored includes a media stream identifier for each media stream received. In this embodiment the media streams are received over an RTP/RTCP protocol which uses packets including a SSRC identifier for each media stream. In this embodiment the configuration data also includes video width and height in pixels provided by the video codec 115. In this embodiment the video codec is Theora. The configuration data also includes video frame rate provided by the application video codec. The media stream identifier, video width and height, and video frame rate are properties of the input media stream. The configuration data also includes data in the form of a list of media stream identifiers defining which of the input media streams, captured remotely or locally, are to be included in the output media stream for presentation via a local display hardware interface 117 for presentation at one of the displays 118a or 118b. In this embodiment, the output media stream is used to present the graphical user interface in addition to input media streams. In this embodiment therefore, the configuration data includes data defining the configuration of the graphical user interface. This data includes the position of a cursor and the condition of controls such as buttons in the graphical user interface.

In this embodiment the configuration data also includes a configuration for the presentation of each input media stream as part of the output media stream. The configuration data includes the state of visibility of each input media stream in the output media stream. In this embodiment, the state visibility includes whether each input stream is visible, or included, in the output media stream. Also in this embodiment, the state of visibility includes whether the media stream is docked and not presented at a display. Also in this embodiment, a local display hardware interface 11 has a number of video and audio outputs for a corresponding number of display screens and the configuration data defines which output, or display screen, each input media stream is to be presented. In this embodiment the display hardware interface has a graphics card with an output, or channel, for each display. The reader will be aware of other parameters to be stored by the configuration data store to arrange, or organize, the look of a video-collaboration presentation or which media streams are included in the presentation.

The data stored by the configuration data store 116 also defines configurations for media streams output by the application 111 at the local display hardware interface 117, which interfaces with a display to present output media streams. Adjustments to the configuration data for apparatuses 101 used with two or more displays 117a and 117n will be apparent to the reader. Table 2 gives an example of configuration data stored in the configuration data store 11.

TABLE 1

| Field Name | Field Description | Example |
|---|---|---|
| SSRC | media stream identifier | 12155125 |
| Media width | original media width in | 320 |
| | pixels | |
| Media height | original media height in | 240 |
| | pixels | |
| Media framerate | framerate (frames/s) of the | 30 |
| | media stream | |
| Mouse x position | x position of the mouse | 30 |
| | cursor on screen | |
| Mouse y position | y position of the mouse | 25 |
| | cursor on screen | |
| Mouse button | state of the mouse button | button 1 clicked |
| condition | | |
| Selected Window | handle of the window | OS dependent (known to |
| | currently selected by the | the reader) |
| | user | |
| Screen dimension | Screen dimension | Screen 1 (1024 × 768) |

A media stream indexing and grouping data store stores 119 SSRC data for each media stream. As known to the reader, the SSRC is a unique identifier provided by the RTP protocol implemented by the networking interfaces 102 of apparatuses 101 participating in a video-collaboration session. The media stream indexing and grouping data store 119 also stores SSRC mapping data which maps media streams to participating apparatuses 101 and the user of the participating apparatus 101. The media stream indexing and grouping data store 119 also stores data identifying the media format, such as video (H264, MPEG-2) or such as audio (G.711, Speex) and type of media stream based on latency, frame rate and resolution or quality. The media stream indexing and grouping data store 119 also identifies network locations of participating apparatuses 101.

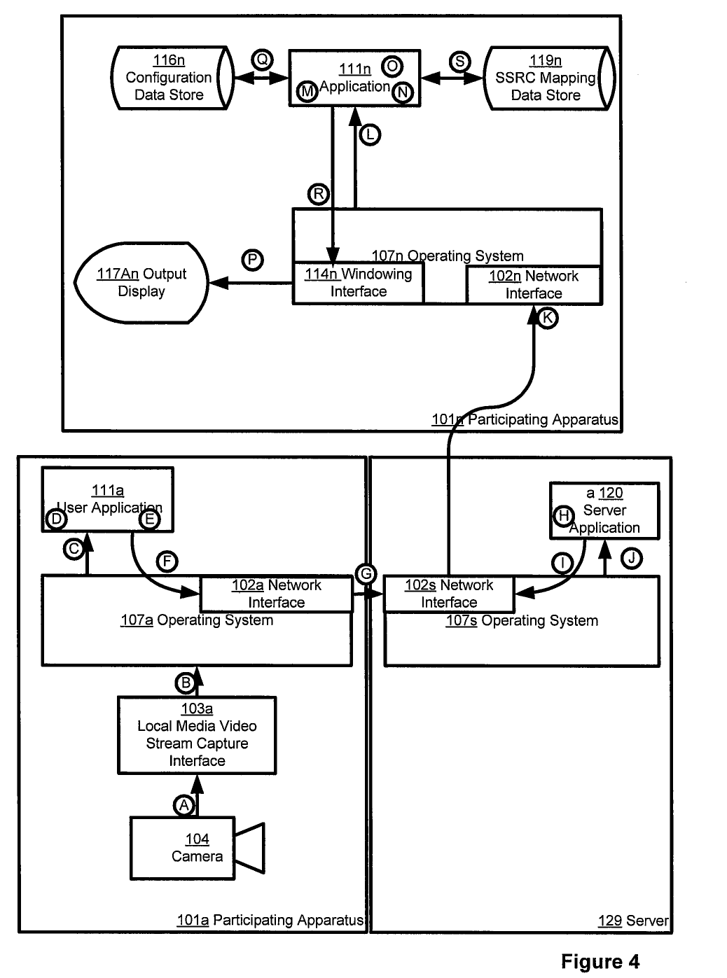

The flow of data and media streams according to another preferred embodiment of the present invention are illustrated with reference to FIGS. 4 to 6.

FIGS. 4 to 6 illustrate the flow of data and media streams between parts of the apparatus 101 to illustrate the function of parts of the apparatus 101, video-collaboration network 2 and server 9. Reference numerals used in respect of the embodiments of the invention illustrated with reference to FIGS. 1, 2 and 3. have been used to indicate similar parts in the embodiment illustrated in reference to FIGS. 4 to 6.

FIG. 4 shows a two apparatuses 101a and 101n participating in a video-collaboration session. As shown, each apparatus has an application software module 111, a configuration data store 116, a The apparatuses 101 are shown connected by a video-collaboration session.

FIG. 4 shows two apparatuses 101a and 101n participating in a video-collaboration session. A server 129 connects the two apparatuses. A video signal A is generated by the video camera 104 and captured as a video media stream B by the local media video stream capture interface 103 for transport by operating system 102. In this example the media stream is encoded by the interface 103 into the standard H.264 format. Media streams C and D are also received by the application 111 from a static graphics interface 106 and a moving graphics interface 106. These streams represent images or presentations run on a computer associated with the apparatus 101. In this embodiment images and presentations are run on the same computer running the application 111 to provide the apparatus.

Video streams are delivered in parallel, while audio stream are multiplexed into a mixed stream. The media stream G is transmitted by the networking interface 102a to the networking interface 102s of the server 129 and onto a server application 120.

The server application 120 passes media streams received by the networking interface 102s to a participating apparatus 101n. Table 2 shows the different media streams in typical formats.

TABLE 2

| Media Stream | Media Stream Type | Format/Protocol |
|---|---|---|
| Video | High Frame Rate | H.264 over RTP + |
| | | UDP |
| Presentation | Low Frame Rate | H.264 over RTP + |
| | | UDP |
| Images | Static Image | JPEG/PNG over |
| | | HTTP |

The groups of media streams K are received by the networking interface as input media streams. In this embodiment they are received in the formats illustrated in Table 3 and are transported by the networking interface 102n. Suitable algorithms for transportation are known to the reader. The application 111 also receives input media streams M, N and O captured locally and input at interfaces (not shown) corresponding to the local media video hardware capture interface 103, the local media audio capture interface 105, the static graphics interface 106 and the moving graphics interface 107.

The application 111n generates an output media stream P for presentation at the display 117An using the window handling API 114n. The output media stream configured dependent on configuration data Q stored by the configuration data store 116n.

The application 111n inputs data identifying media streams, grouping of media streams and SSRC data in the SSRC mapping data store 119n, which correspondes to the data store 119 illustrated in reference to FIG. 3. The SSRC identifies the media stream transmitted and received. The SSRC for each stream is known to all participants before the delivery of data streams. The participant matches the SSRC in the data packet received with the mapping data known to all participants in the conference to determine the origin (the participant) of the stream.

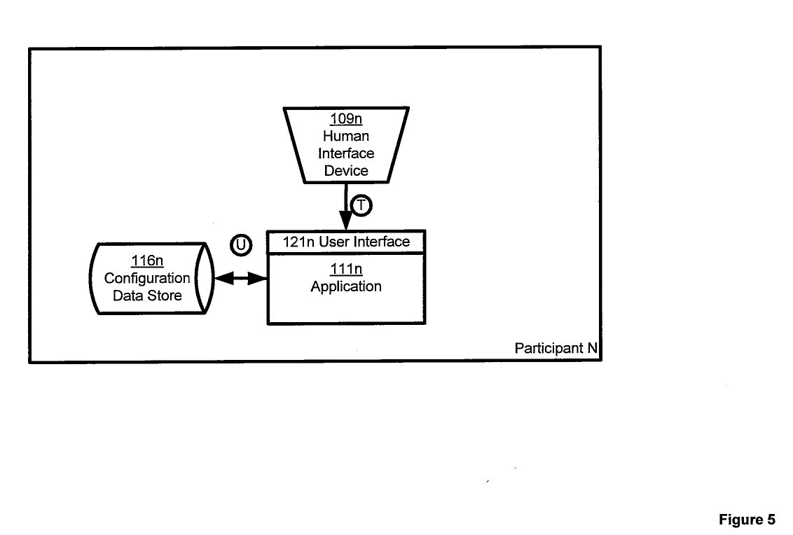

FIG. 5 illustrates a process in which the configuration data store 116 is updated to reflect a configuration for the presentation of input media streams at a display, such as 117An shown in FIG. 4. The user controls a human interface device (not shown) provided in this embodiment by the computer terminal 109n. In this example the human interface device 109n is a mouse (not shown). The user controls the mouse to generate events T captured by the user interface 121n. The user interface 121n is formed by modules similar to those shown in FIG. 3, such as the human interface device interface 110, windows event handler 115 and GUI interface 112. The configuration data U is then stored by the application at the configuration data store 116n.

At S1-4 the application 111 updates a thumbnail panel 204 with a list of objects 205a to 205c. Each object 205a to 205c represents a media steam to be presented at the various displays 117a to 117d. In this embodiment an object 205 is a moving, or dynamic, graphical thumbnail representation of an input media stream with reduced size, resolution and bandwidth. In this example the thumbnail is a miniature of a window at the display in which the respective media stream is presented. The miniature window shows a lower resolution, lower frame rate moving image. Typically, the media stream will be video and audio streams or static or moving media graphics streams. These will be received by the networking interface 102 or captured locally by the local video and audio hardware capture interfaces 103 and 105 or the static or moving graphics interfaces 106 or 107. In this embodiment also, the object is visually distinguished as representing a media stream which is presented at a display 117. The process ends at S1-4.

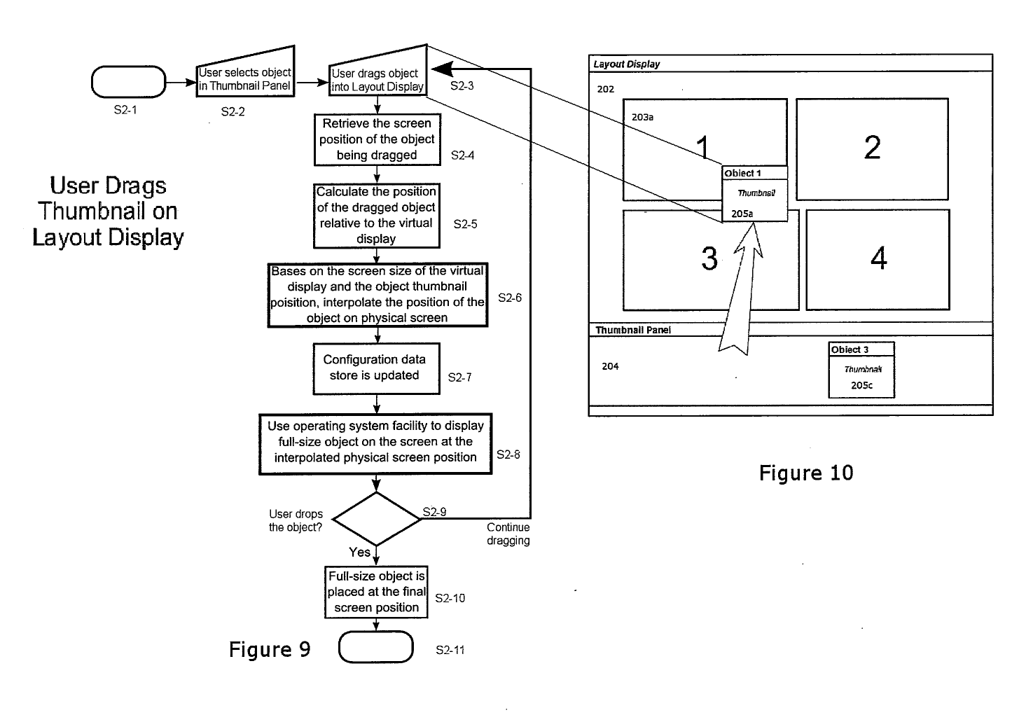

FIGS. 9 and 10 illustrate a process in which the graphical user interface allows the user to configure the presentation of output media streams presented at the displays a display 117a to 117d. In this example the user includes, or selects for display, an input media stream in an output media stream for presentation at a display 117a. It will be apparent to the reader that the operations described below will involve the window event handler 115, the GUI interface 112, the window handling API 114 and other known parts of the operating systems. In particular the application generates the graphical user interface using the GUI interface 112, and the window handling API 114, and captures events representing user interactions with the graphical user interface using the windows event handler 115.

The process begins at S2-1. At S2-2 the user selects an object 205a.

At S2-3 the user drags the object 205a it into the display panel 202 and, specifically, into screen panel 203a and, more specifically, to a position within the screen panel 203. In this embodiment, this action represents the user wanting the media stream represented by the object 205a to be presented at a corresponding position in the display 117a.

At S2-4 the application 111 retrieves the position of the object 205a.

At S2-5 the application 111 calculates the position of the object 205a relative to the screen panel 203a.

At S2-6 the application interpolates the required position of a window in which the media stream represented by the object 205a will be presented relative to the display 117a. The application 111 does this based on the size of the screen panel 203a and the position of the object 205a.

At S2-7 the configuration data store is updated. These configuration data include screen coordinates of each object, screen dimension of each object and visibility of each object

At S2-8 the application 111, using the windows handling API presents at the display 117a the input media stream represented by the object 205a. The operating system provides the facility for the application to display an encoded media stream on screen. The operating system encapsulates the functionality for converting the encoded media into the low-level instruction expected by the hardware.

At S2-9 the user drops the object 205a.

At S2-10 the window including the input media stream is placed at the final position as presented at the display 117a. The process ends at S2-11.

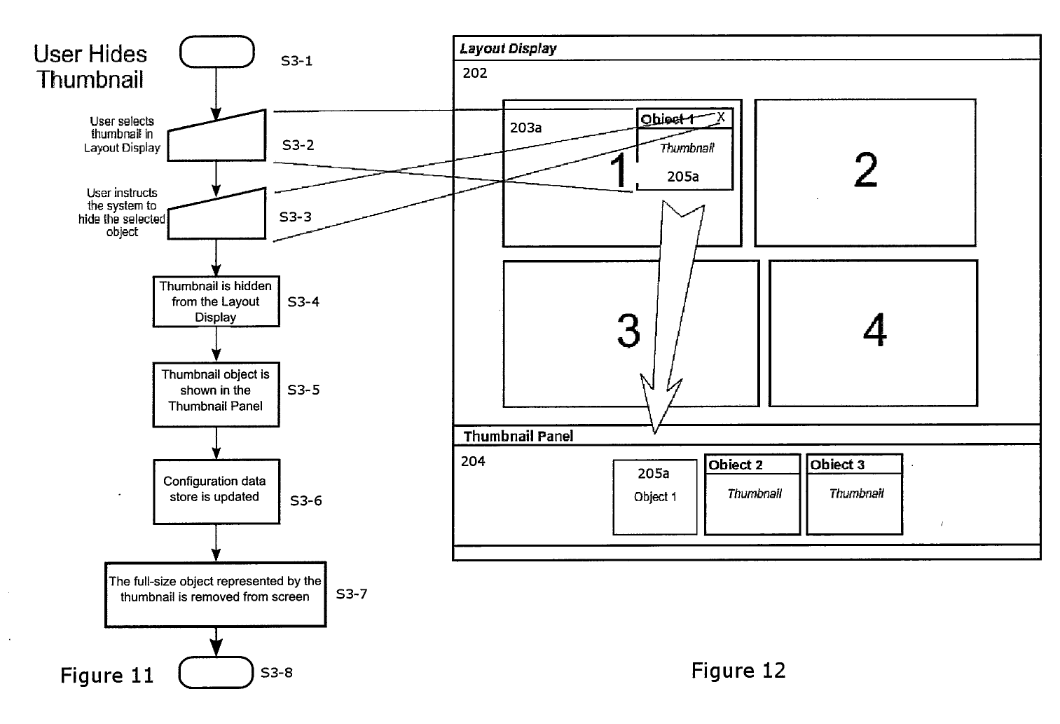

FIGS. 11 and 12 illustrate a process in which the user configures the presentation of an output media stream by hiding, removing or deselecting an input media stream for presentation at a display 117a.

The process begins at S3-12. At S3-2 the user selects an object 205a from within the display panel 202, and within a specific screen panel 203a. At S3-3 the user drags the object 205a to the thumbnail panel 204. This indicates that the user wishes the input media stream represented by the object 205a to be removed, or deselected, from presentation the display 117a.

At S3-4 the application hides the object 205a from the screen panel 203a.

At S3-5 the application shows the object 205a in the thumbnail panel 204.

At S3-6 the configuration data store 116 is updated to indicate that the media stream represented by the object 205a is not to be presented.

At S3-7 the media stream represented by the object 205a is removed from the output media stream presented at the display 117a. The process ends at S3-7.

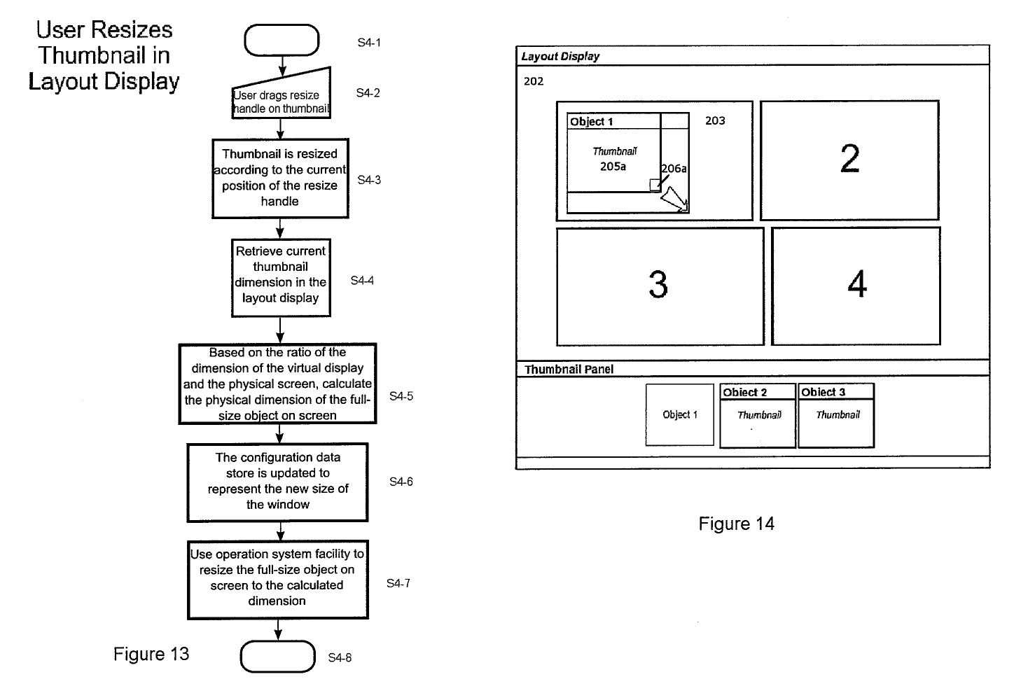

FIGS. 13 and 14 illustrate another process in which the graphical user interface allows the user to configure the presentation of output media streams presented at the displays a display 117a to 117d. In this example the user resizes a window in which an input media stream is presented at a display 117a.

The process begins at S4-1. At S4-2 the user drags a handle 206a on the object 205a to indicate a resizing of the window in which the input media stream represented by the object 205a is presented.

At S4-3 application 111 resizes the object based on the current position of the resize handle 206a.

At S4-4 the application 111 retrieves the current object dimensions in the layout panel 202.

At S4-5 the application 111 calculates the dimensions of a window in which the input media stream represented by the object 205a. The application does this based on the dimensions of the screen panel and the window presented at the display 117a.

At S4-6 the configuration data store is updated to represent the new size of the window in which the media stream represented by the object 205a is presented at the display 117b.

At S4-7 the application uses a native facility as apparent to the reader, provided by the operating system 107 to resize the window in which the media stream represented by the object 205a is presented at the display 117b. The process ends at S4-8.

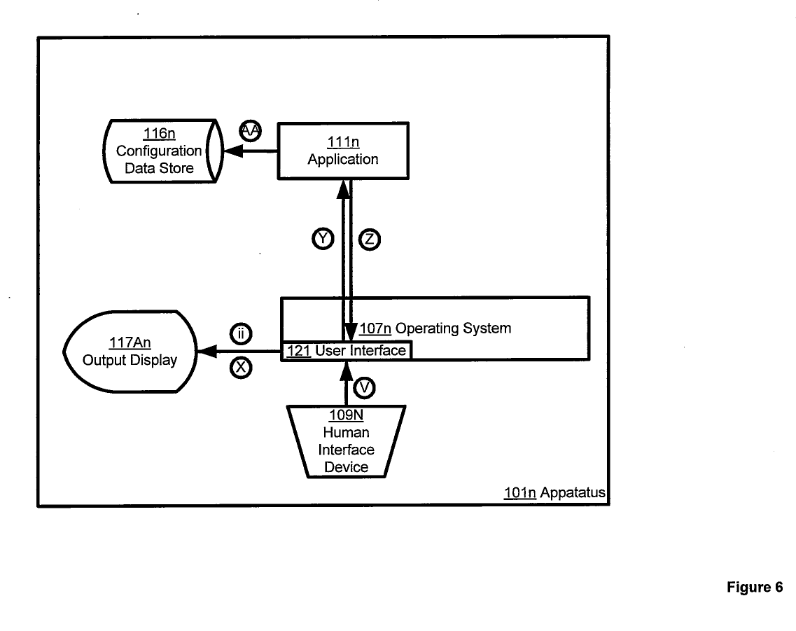

FIG. 6 illustrates a process in which a participating apparatus 101n according to the embodiment of FIGS. 4 and 5 allows configuration data stored at the configuration data store 116n to be updated. In one example the data is updated to resize a window in which an input media stream is presented at the display 117n.

A user inputs control events V using a human interface device provided in this embodiment by a computer terminal 109n to interact with a graphical user interface (not shown) generated via the user interface 121n. The graphical user interface (not shown) in this embodiment provides a graphical representation, although smaller and lower resolution and higher latency, of the output media stream X as presented at the display 117n and therefore is itself configured using configuration data Y. The events are provided to the application 111n in an application protocol, as data Z to the application 111n. The data Z in provided by the windows event handler 115, similar to that shown in FIG. 3. The application 111n stores updated data AA at the configuration data store 116n.

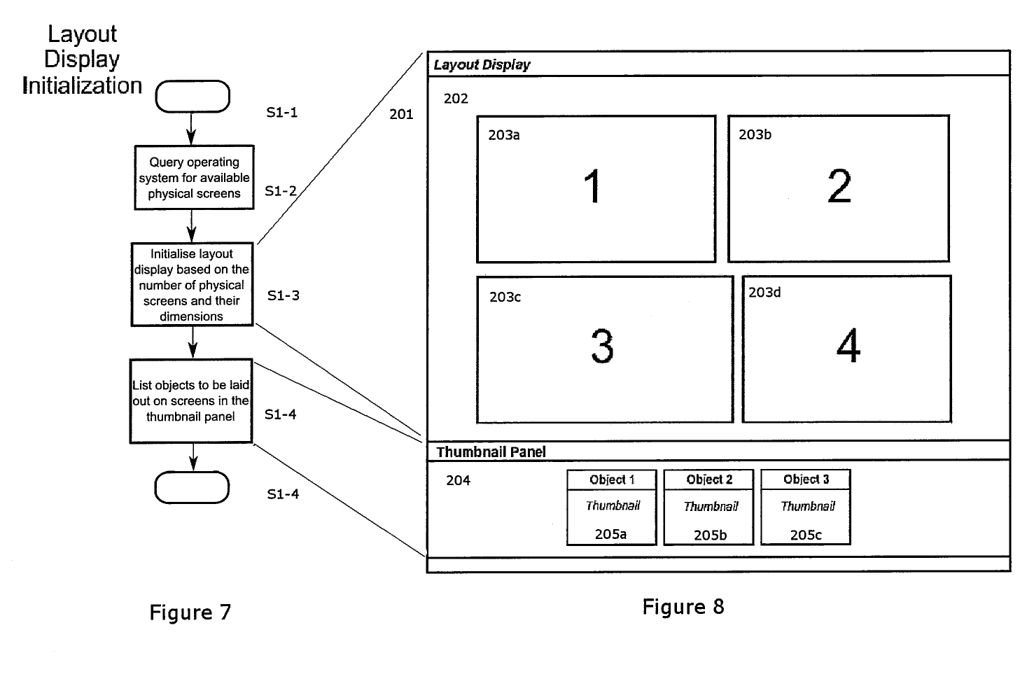

Exemplary processes carried out by apparatuses, such as 1 or 101 but according to an alternative embodiment, are illustrated with reference to FIGS. 7 to 14 to illustrate the function of the various parts of the apparatus.

FIGS. 7 and 8 illustrate a process for initialization of the graphical user interface 201 presented by the GUI interface 112. The graphical user interface 201 is presented at the local computer terminal 109. The process begins at S1-1. At S1-2 the application 111 queries the operating system 107 for the number of screens provided by the local display hardware interface 118. In this embodiment a different screen is provided as a display for each of the four displays 117a to 117d by different channels of a graphics card forming part of the local display hardware interface 118.

At S1-3 the application 111 initialises layout display panel 202 of the graphical user interface based on the number of displays and the dimensions of the displays. In this embodiment the four displays are represented by screen panels 203a to 203d. The dimension of the screens or displays are accessible through an API provided by the operating system.

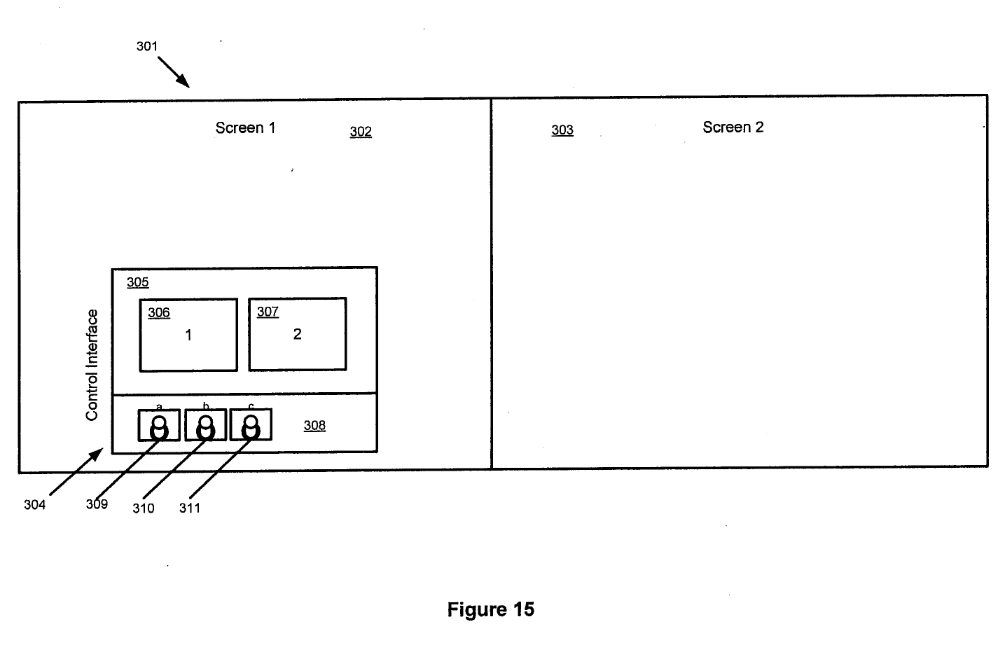

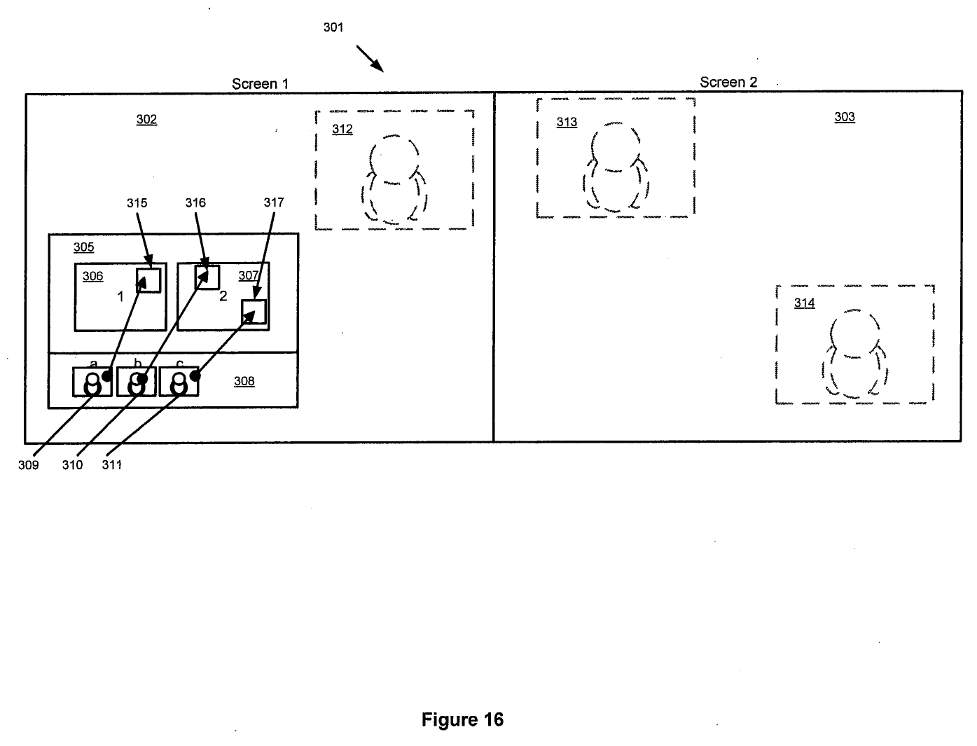

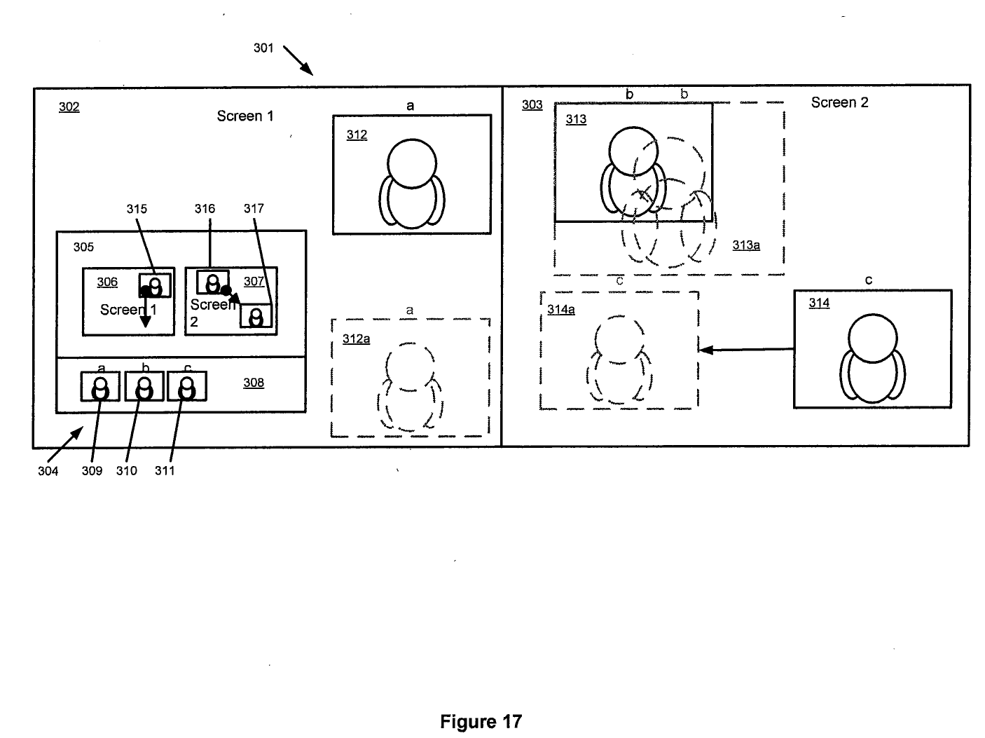

FIGS. 15 16 and 17 show another embodiment in which provides a screen video collaboration presentation 301a first screen 302 and a second screen 303 and a control interface, or graphical interface 304 which configures the first screen 302 and second screen 303. In this embodiment the graphical interface 304 is displayed in on screen 1. The graphical user interface 304 of this embodiment has a screen dock 305 with screen objects 306 and 307 which represent screens 302 and 303 of the video presentation. In this embodiment a user can manipulate the screen objects 306 and 307 to configure the screens and the screen objects provide a representation of the screens 302 and 303. The graphical user interface of this embodiment also has a data dock 308 which has input stream objects 309, 310 and 311 representing input media streams. The input media streams, if all are selected for display at the screens 302 and 303, are displayed as display streams, or windows, 312, 313 and 314. The graphical interface 304 has objects 315, 316 and 317 which represent the display streams 312, 313 and 314 as they are displayed. In this embodiment the objects 315, 316 and 317 are dynamic graphical representations in the form of which display input media streams at reduced size and reduced resolution. The objects are generated after the user drags the objects 309 310 and 311 from the data dock 308 to the screen dock 305. The positions and sizes of the objects 315, 316 and 317 in the screen objects 306 and 307 represent and configure the positions of the windows 312, 313 and 314 displaying input streams on the screens 302 and 303 of the presentation 301. Maniplualtion in the graphical user interface 304 of objects 315, 316 and 317 causes configuration data to be generated and/or updated and that generated and/or updated configuration data causes the configuration of windows 312, 313 and 314 to be changed or updated. FIG. 16 illustrates input stream objects 309, 310 and 311 being dragged onto the screen objects 306 and 307, in the screen dock 305, to generate and/or update configuration data to cause windows 312, 313 and 314 to be generated to display input media streams corresponding to the input streams represented by the input media stream objects 309, 310 and 311. FIG. 17 illustrates the object 315 being moved in object 306 of the graphical user interface 304 to cause the widow 312 to move to the position indicated by window 312a. FIG. 17 also illustrates the object 316 being resized to resize the window 313 as depicted by the window 313a. Also illustrated in FIG. 17 is the window 314 being manipulated directly, and independently from the graphical user interface 304. It is apparent that the graphical user interface 304 of this embodiment allows control of the configuration of the presentation 301 without a user needing to manipulate the presentation 301 directly.

However, in this embodiment the user may optionally manipulate the presentation 301 diorectly. Therefore, the graphical user interface 304 provides an additional control to the presentation 301 which may be controlled directly. The graphical interface 304 of this embodiment also replicates the media streams as displayed to allow a user to control the presentation. The user is able to do this in real time, and alter the presentation based on the input media streams and the presentation 301. The user of this embodiment can also make adjustments without necessarily directly manipulating the presentation 301.

Alternative embodiments may display the graphical user interface 204 may be displayed at a computer display (not shown) of a computer associated with the apparatus. Other embodiments may have more than two screens.

Further embodiments of the invention are illustrated below.

In some embodiments the apparatus 1 or 101 transmits data to the server to identify which media streams are required from other apparatuses 3, 4 and 5. For example, the data may identify that media streams from a given video-collaboration apparatus 3, 4 or 5 are not required, or perhaps that only some specific media streams, or types of media stream, are required from a given, or each, apparatus 3, 4 or 5.

In some embodiments the apparatus 1 or 101 may be provided by the computer 8 which captures documents and multimedia and at which the graphical user interface is presented to a user.

In some embodiments the apparatus may present media streams at more than two displays 117. In some embodiments also, computer terminal hardware 109 may be used as a display, similarly to displays 117a or 117b. In some embodiments also, the computer terminal may be the only display used.

In some embodiments the apparatus 1 or 101 may be implemented on the same computer that provides the computer terminal. In these embodiments the apparatus is provided by a personal computer or laptop which runs and application 111 from a program memory (not shown). The various interfaces are provided by code modules, or interfaces, controlling peripheral hardware of the computer and using program and data memory of the computer. In other embodiments the apparatus may be implemented using a dedicated computer separate from the computer providing the computer terminal. Suitable computers, peripheral hardware, hardware drivers, and memory will be apparent to the reader.

In some embodiments the graphical user interface may allow a user to drag an object from a candidate field towards a presentation field. In these embodiments a copy of the object may be generated and presented in the presentation field. The copy may be static wheras the object in the candidate field is dynamic or moving to provide a representation of a respective media stream.

In some embodiments, code modules providing the interfaces, CODECs, and application and data stores described herein may be combined or divided. As understood by the reader various code modules may require compilation and/or instantiation to provide the structure and function illustrated with respect to the drawings provided. Suitable combinations or divisions will be apparent to the reader. In some embodiments interfaces are formed of code modules and hardware. Suitable hardware will be apparent to the reader.

Various embodiments use different human interface devices including mouse, touch pads, camera systems, and audio systems.

In some embodiments, thumbnails, or objects representing media streams are distinguished visually to indicate whether or not the media stream represented by the thumbnail is presented at one of the displays 117. In some embodiments the thumbnails or objects are distinguished by colour. In other embodiments other means for distinguishing the thumbnails or objects, including shading, fading, outlining, or any other means for indicating a difference in status for a thumbnail or object.

In some embodiments of the invention the media streams received at the network and other interfaces include only video streams.

Some embodiments of the present invention are implemented using a carrier medium which stores computer, or processor, executable instructions. When the instructions are executed they configure the computer to provide apparatuses or carry out methods as described herein with reference to the drawings. The computer has peripheral hardware to provide interfaces to the video-collaboration network hardware external to the computer of to applications running static or moving images, graphics and presentations. Suitable hardware peripherals and executable code to provide the interfaces applications and functional units and carry out processes described herein are apparent to the reader also. Various alternative embodiments combine and/or divide the interfaces, applications and functional units or steps in processes described herein in various suitable manners known to the reader also. Embodiments of the invention may use any carrier medium known to the reader, computer memory, FLASH memory, EEPROM devices, magnetic or optical media, or electromagnetic, optical or electrical transmission media using any protocol known to the reader such as over TCP/IP. In some embodiments the carrier medium may be provided as a software product.

In some embodiments the configuration data defines various combinations of the following.

For video: 1) Width and height in pixels; 2) Frame rate in frames/sec 3) Contrast, brightness, hue 4) Image smoothing 5) Pausing or playing state.

For audio: 1) Sampling rate (affects quality) 2) Number of channels (mono, stereo or multi-channels) 3) Volume 4) Mute or playing state 5) Equalization 6) Gain.

In some embodiments the configuration data includes a list of identifiers for input media streams which have been selected by the user for inclusion in the output media stream. In these embodiments the inputs by the user at the graphical user interface define a list of input media streams and the user interface obtains identification data in the form of SSRC data for each of the input media streams in the list defined at the user interface. The user interface, of application, then generates a list of identification data in the configuration data. The list of identifiers is used by the output generator to handle, or call, the input media streams when generating the output media stream.

In some embodiments the apparatus, such as 1 or 101, may receive input media streams from a network which has only one other participating apparatus and the network may not have a server, such as 9. In one example the video collaboration network may be a peer-to-peer network with only two participating apparatuses, such as 1 and 3 for example.

In some embodiments objects representing media streams from the same apparatus 3, 4 or 5, or in the same group, A, B or C, are grouped together in terms of their position on the candidate field of the graphical user interface. In another embodiment object in the same group A, B or C may be given a tag identifying the origin, such as apparatus 3, 4 or 5. In another example objects representing media streams from in each group, A B or C may have a coloured border to allow the user to distinguish the groups. This may allow, for example, a user to see that a video stream of a use of a participating apparatus is grouped with a stream of a power point presentation and a word document which the user of that apparatus wants to present in the video collaboration. The user who is configuring the video collaboration presentation at another apparatus may drag the object representing only the video stream initially. Then tey may want to see the Powerpoint™ presentation. By a tag, or position or colour they will readily be able to find which Power Point™ stream originated at the same apparatus as the video stream.

In some embodiments hardware for generating or capturing media streams may be associated with the apparatus by data connections which may be local to the apparatus. The associated hardware may be connected by computer peripheral interfaces and/or by local area networks.

In embodiments in which the apparatus is used with only one display device the apparatuses may provide only one output media stream. However, in embodiments used with additional display devices, the apparatus, such as 1 or 101, may output additional output media streams for additional display devices. In some embodiments the local display hardware interface, such as 118, or presentation interface, such as 12, may have a graphics card with a channel or output for each display device and the apparatus may generate an output media stream for each channel.

In some embodiments the output media stream may be generated by an application, such as 111. In other embodiments the output media stream may be generated by a generator such as 15. In some embodiments the output media stream may be generated simply by combining input media streams where the combining is dependent on configuration data.

In some embodiments the output media stream may have a separate window for each input media stream as it appears in the presentation of the output media stream and the presentation of the output media stream may have a window which contains these windows for input media streams. The configuration data may define the layout of the windows for input media streams within the window for the output media stream.

Other embodiments of the invention provide a video-collaboration apparatus operable to present one or more media streams received from a video-collaboration network which generates a user interface which receives inputs from a user to arrange and/or adjust the layout of media streams as presented. The video-collaboration apparatus may also display media streams which are captured locally at the apparatus. The user interface may present a graphical representation of the media streams as presented and allow the user to manipulate the layout of said graphical representation to define a layout for the presentation of the media streams. The user interface may present thumbnail representations of windows in the presentation, in which windows the media streams are displayed and allow the user to manipulate the thumbnails. The user interface may present a candidate panel and a display panel for the thumbnails wherein a thumbnail located in the candidate panel represents a media stream as a candidate for display and wherein a thumbnail located in the display panel represents a media stream which is to be presented. The user interface may visually distinguish thumbnails located in the candidate pane to distinguish thumbnails which represent media streams that are presented from thumbnails which represent media streams which are not to be presented. The presentation may be made at two or more displays associated with the apparatus. The user interface may allow the user to adjust the position of given thumbnails within the graphical representation to define adjustments in the position of windows in which media streams represented by the given thumbnails are presented. The network interface may be operable to identify an origin for media streams received over a video-collaboration network. The network interface may be operable to receive groups of media streams, grouped by origin, wherein each group comprises at least one video stream. The network interface may be operable to transmit to the video-collaboration network one or more media streams, wherein said one or more media streams transmitted includes one or more video streams. The apparatus may present media streams at more than one display. The user interface may present a different display pane for each display.

The reader will understand that the various embodiments described herein are exemplary only and various alternative embodiments within the scope of the claims, which define the scope of the invention, will be apparent.

1. A video-collaboration apparatus operable to provide a video-collaboration presentation, the apparatus including:
an input interface operable to receive one or more input media streams;
a presentation interface operable to output an output media stream to a display to provide the video-collaboration presentation, the output media stream including one or more of said one or more input media streams to be presented at the display;
a user interface operable to capture configuration events caused by the user and generate configuration data dependent on said configuration events;
an output generator operable to generate the output media stream dependent on the configuration data to display one or more of the input media streams in the video-collaboration presentation configured by the events caused by the user,
and wherein the user interface is operable to generate a graphical user interface to capture configuration events,
and wherein the graphical user interface generated includes one or more objects representing the one or more displayed input media streams.

2. The apparatus of claim 1 wherein the one or more objects provide a graphical representation of the input media streams included in the video-collaboration presentation.

3. The apparatus of claim 2 wherein the graphical representation is a dynamic graphical representation having a size, resolution, frame rate or latency that is lower that that of the media stream displayed in the video-collaboration presentation.

4. The apparatus of any one of the proceeding claims wherein the graphical user interface replicates the video-collaboration presentation to allow a user to configure the video-collaboration presentation by manipulating the graphical user interface.

5. The apparatus of any one of the preceeding claims including a computer interface operable to receive one or more media streams from a computer associated with the apparatus.

6. The apparatus of any one of the preceding claims including a hardware interface operable to receive one or more media streams from hardware associated with the apparatus.

7. The apparatus of any one of the preceding claims wherein the network interface is operable to receive media streams in two or more media types, each type corresponding to a different latency and/or bandwidth on the video-collaboration network.

8. The apparatus of any one of the preceding claims wherein the user interface is operable to generate configuration data defining whether a given one of the one or more input media streams are to be included in the output media stream for presentation at the display.

9. The apparatus of any one of the preceding claims wherein the user interface is operable to generate configuration data defining a layout for the video-collaboration presentation.

10. The apparatus of any one of the preceding claims wherein the user interface is operable to generate configuration data defining a layout having a position for each input media stream as presented within the video-collaboration presentation.

11. The apparatus of any one of the preceding claims wherein an object included in the graphical user interface represents a respective input media stream replicates the respective input media stream.

12. The apparatus of claim 11 wherein the user interface is operable to generate a graphical user interface which replicates the video-collaboration presentation with a size reduced relative to that of the video-collaboration presentation.

13. The apparatus of claim 11 or claim 12 wherein the user interface is operable to generate a graphical user interface which replicates the video-collaboration presentation with a resolution reduced relative to that of the video-collaboration presentation.

14. The apparatus of any one of claims 11 to 13 wherein the user interface is operable to generate a graphical user interface which replicates the video-collaboration presentation at a frame rate reduced relative to that of the video-collaboration presentation.

15. The apparatus of any one of claims 11 to 14 wherein the user interface is operable to generate a graphical user interface including a candidate field for objects representing input media streams as candidates for inclusion in the output media stream and to allow the user to copy and/or move objects from the candidate field to the presentation field.

16. The apparatus of any one of claims 11 to 15 wherein the user interface is operable to generate a graphical user interface which allows a user to cause configuration events by manipulating the objects within the presentation field to move and/or resize objects within the presentation field to capture configuration data determining positions for given input media streams presented within a layout of the video-collaboration presentation.

17. The apparatus of any one of the preceding claims wherein the network interface is operable to extract identification data from the input media streams, the identification data identifying an origin in the video-collaboration for the media stream.

18. The apparatus of claim 17 wherein the identification data further identifies groups of media streams having a common origin and wherein each group from a common origin includes a video stream.

19. The apparatus of any one of the preceding claims wherein the presentation interface is operable to provide additional output media streams for presentation at additional displays.

20. A method of controlling one or more displays for a video-collaboration apparatus, each display presenting a first video stream including one or more second video streams received by the video-collaboration apparatus to provide one or more first video stream presentations, the method comprising:
receiving the one or more second video streams;
presenting a graphical user interface including objects representing the one or more first video presentations;
receiving events caused by a user at the user interface to allow the user to configure one or more video presentations;
generating configuration data using the events; and
adjusting the one or more first video stream presentations dependent on the configuration data.

21. The method of claim 20, wherein the one or more objects provide a graphical representation of the input media streams included in the video-collaboration presentation.

22. The method of claim 21 wherein a graphical representation is a dynamic graphical representation having a size, resolution, frame rate or latency that is lower that that of the media stream displayed in the video-collaboration presentation.

23. The method of any one of the proceeding claims wherein the graphical user interface replicates the one or more input media streams displayed in the video-collaboration presentation.

24. The method of any one of claims 20 to 23, comprising indicating groups of objects that represent video streams from common origins.

25. An apparatus operable to present media streams for a video-collaboration session, the apparatus including, a processor, a data memory, and a program memory storing instructions which are executable by the processor to configure the apparatus to include:
a network means operable to receive one or more input media streams from a video-collaboration network, each input media stream including a video stream;
a presentation means operable to output an output media stream to a display to provide the video-collaboration presentation, the output media stream including one or more of said one or more input media streams to be presented at the display;
a user means operable to generate a graphical user interface including objects represention the input media streams included in the output media strea, and operable to capture configuration events caused by the user and generate configuration data dependent on said configuration events, the configuration data defining a configuration for the video-collaboration presentation;
a generation means operable to generate a presentation media stream dependent on the configuration data to provide a video-collaboration presentation configured by the events caused by the user.

26. A control for a video-collaboration apparatus, the apparatus operable to display one or more of a set of candidate media streams received from a video-collaboration network, the apparatus configurable to display a given media stream or to not display a given media stream, each media stream displayed being displayed in a display window, the control including a user interface operable to generate a graphical interface displaying a candidate field containing a graphical object representing each candidate media stream and including a presentation field containing an object representing each display window and operable to allow a user to cause events at the graphical interface which add given objects to the presentation field to determine a configuration for the apparatus in which configuration candidate media streams are displayed, and wherein the control is operable to generate configuration data describing the configuration.

27. A carrier medium carrying computer executable code operable to configure a computer to provide the apparatus of any one of claim 1 to 20 or 25 or the control of claim 26.

28. A carrier medium carrying computer executable code operable to configure a computer to carry out the method of any one of claims 21 to 24.
